(19) United States
(12) Patent Application Publication
(10) Pub. No.: US 2010/0212009 A1
(43) Pub. Date: Aug. 19, 2010

(54) Multi-Method Emergency Access

(76) Inventors: Greg Salyards, Austin, TX (US); Shaun Cuttill, Austin, TX (US)

Correspondence Address: Greg Salyards, Suite 402, 930 South Bell Boulevard, Cedar Park, TX, 78613, US

(21) Appl. No.: 12/388,695

(22) Filed: Feb. 19, 2009

(51) Int. Cl. H04L 9/32; G06F 21/00

(52) U.S. Cl. 726/19; 726/7

(57) ABSTRACT

A method or system for providing multiple fallback authentication options via self-service, also known as emergency access, for users to access PC or network systems when their primary authentication method has been lost, blocked or otherwise unavailable.

### BACKGROUND OF INVENTION

1. Technical Field

The system and apparatus described in this disclosure pertains to providing multiple fallback authentication options via self-service, also known as emergency access.

2. Related Technology

Emergency access processes are for singular actions such as self-service reset of a user's password or unblocking blocked smart cards. In no case does a single system provide multiple options of emergency access to a user.

User names and password initially served as a valid means for protecting digital information however, due to the growth of computer processing power, social networking, personnel complacency with regards to security policy and other threats, organizations were forced to strengthen standard user names and password to such an extent that they have now become unusable, expensive to maintain, and in many cases the desired effect of increased security was not achieved.

As an alternative to user names and passwords, organizations have started to adopt stronger forms of authentication, known as two-factor, three-factor and four factor authentication such as contact based smart cards, biometric devices, Knowledge-Based Authentication, identity validation services and One-Time Password tokens.

These newer authentication methods are grouped in to various “factors” of authentication. Whereby physical non-human devices are referred to as “something you have”, human biometrics are referred to “something you are”, human memory is referred to as “something you know” and personal validation of public records or third-party verification services, and the like, are known as “something somebody else knows about you”.

This invention addresses the first three factors of authentication. Historically organizations and system owners have only provided one or, in some cases, two methods of authenticating to PCs or networked based systems. These methods traditionally have been user name, password and some other method, whereby the username and password were constant, such as user name and password OR contact smart card OR user name and password OR fingerprint biometrics.

In some cases organizations and system owners have scrambled or obscured the user's password so that the user could only logon with the alternative means, such as a contact smart card or fingerprint biometric. In rare cases security vendors have written special log on environments that replace the default user name and password logon environment, thereby removing the user's ability to log on with user name and password.

Since the use of two or three-factor authentication requires the use of something the user has or is, there is a high possibility that the user will lose, misplace, block or need to replace these factors from time to time. Within organizations that desire to increase security while at the same time maintain a high level of productivity, the use of self-service processes are preferred.

Commonly organizations decentralize management and provide self-service enrollment and certain lifecycle management capabilities for users to maintain a high level of productivity. On occasion, organizations provide the capability for users to conduct self-service fallback or emergency access in the event their primary authentication method is lost, blocked or otherwise not available.

In all cases these emergency access processes are for singular actions such as self-service reset of a user's password or unblocking blocked smart cards. In no case-does a single system provide multiple options of emergency access to a user.

This invention is designed to provide self-service, multi-option emergency access to users who first are required to remediate an issue with-their primary form of authentication and validate their identity prior to requesting access to a PC or network system.

### SUMMARY OF INVENTION

A method or system for providing multiple fallback authentication options via self-service, also known as emergency access, for users to access PC or network systems when their primary authentication method has been lost, blocked or otherwise unavailable.

### SUMMARY OF DRAWINGS

The features of the invention are believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 illustrates the first step of access to the stand-alone or network based computer system access.

FIG. 2 illustrates the first step of emergency access.

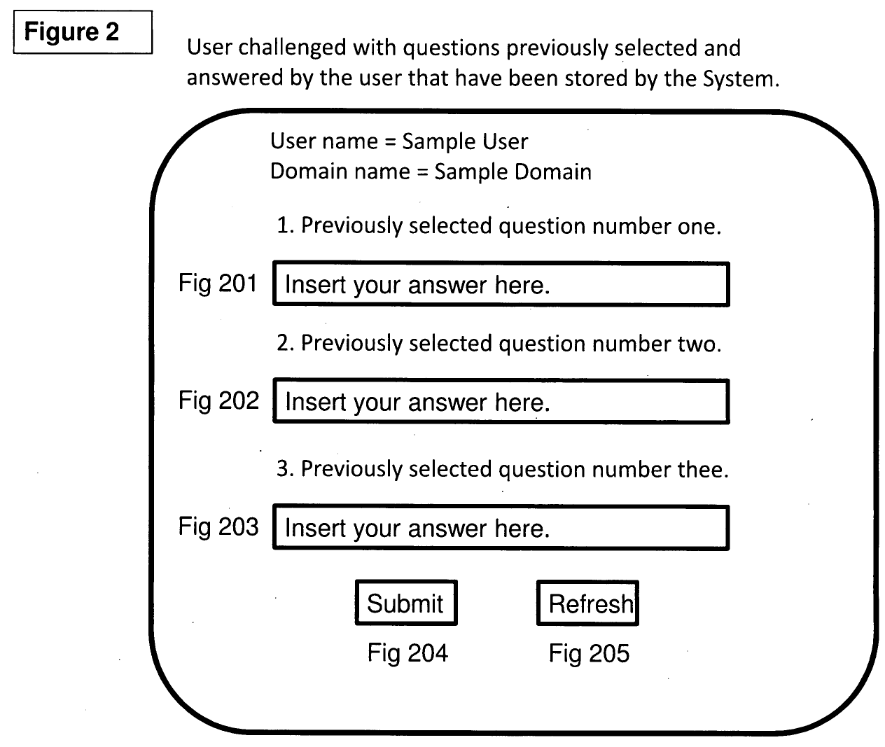

FIG. 3 illustrates unsuccessful emergency access.

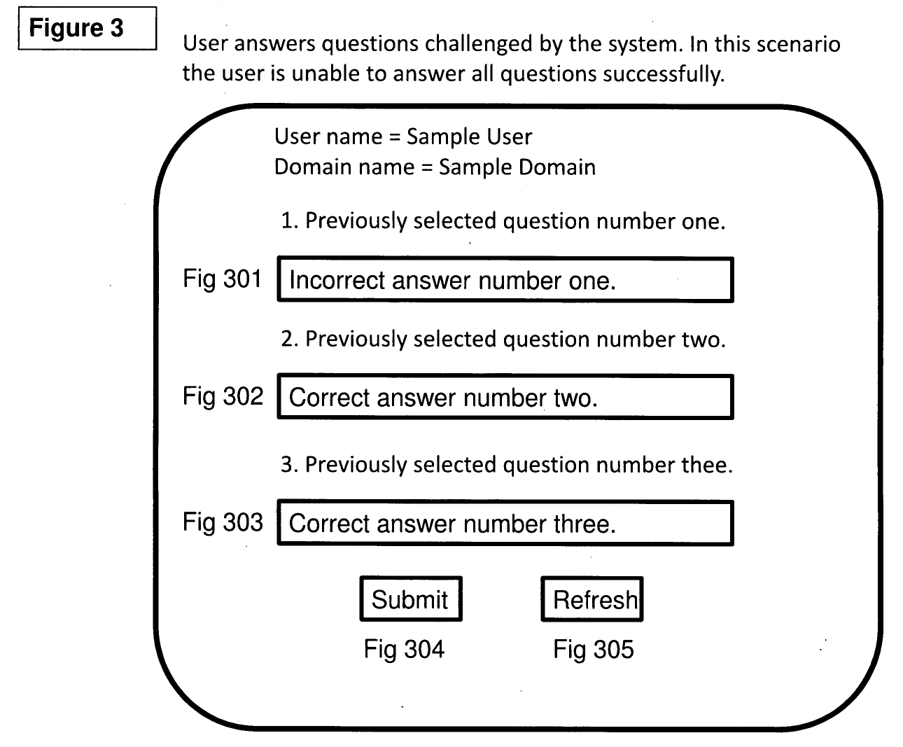

FIG. 4 illustrates successful emergency access.

FIG. 5 illustrates the options provided once emergency access has been granted.

FIG. 6 illustrates the logon option of setting a new pin.

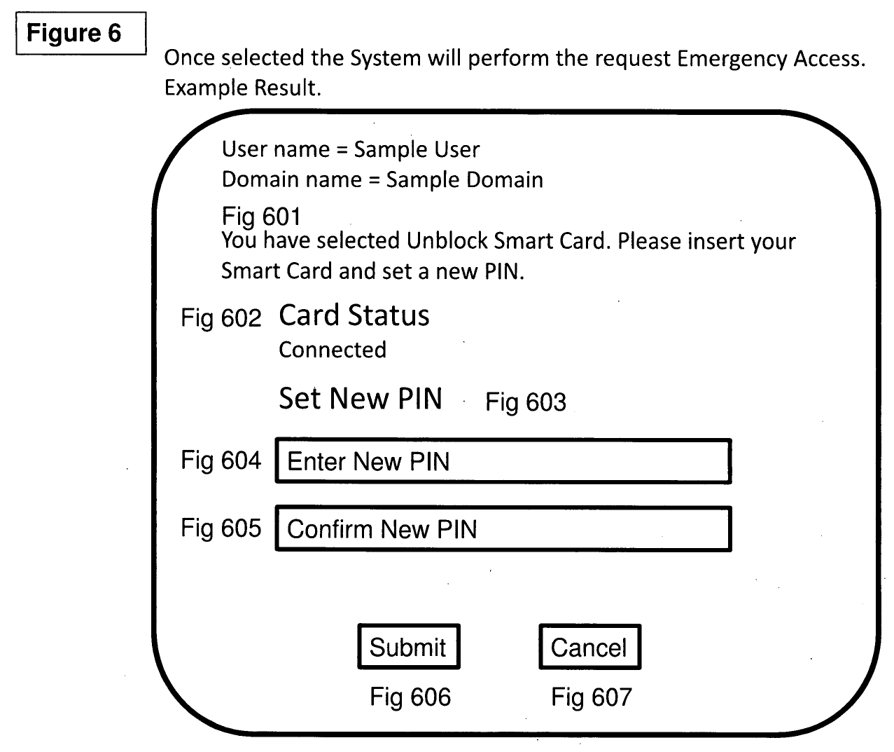

FIG. 7 illustrates the logon option of setting a new password.

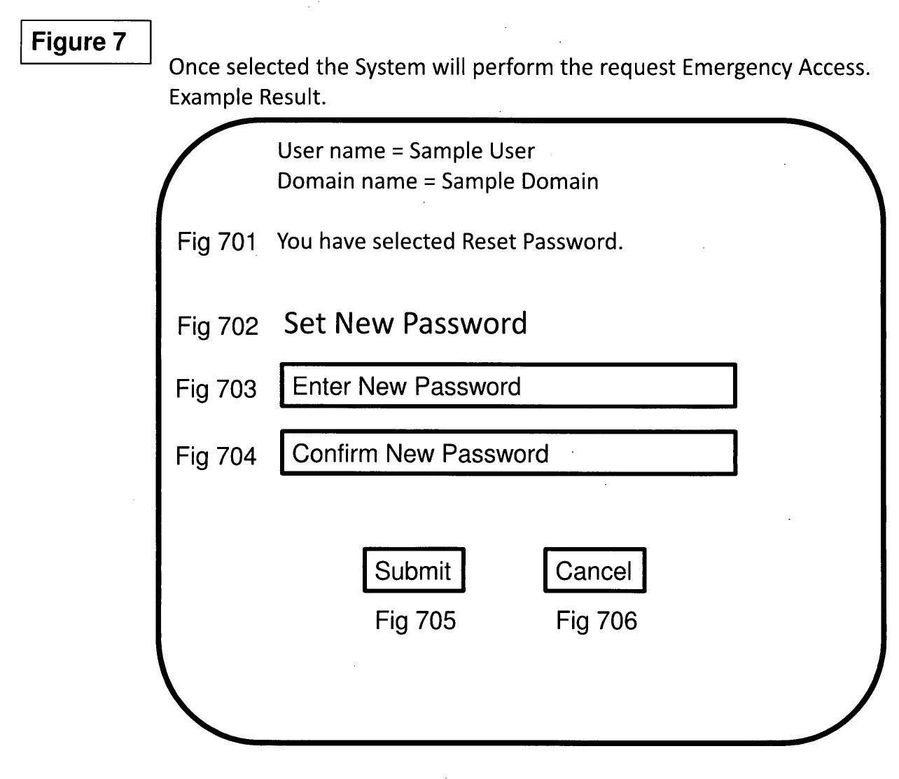

### DETAILED DESCRIPTION OF INVENTION

A security system is for providing self-service, multi-option emergency access to users who are initially required to remediate an issue with their primary form of authentication and validate their identity prior to requesting access to a PC or network system.

The system is a software application that collects, stores and validates information. Self-service is a process performed by the user that does not require the interaction of a third-party. Emergency Access (FIG. 102) is a fallback authentication process used to validate the user before providing validated access to a computer system or enabling the user to remediate the deficiency for which the user required Emergency Access, when the primary form of authentication is not feasible, accessible or known by the user.

The log on environment is, in essence, the front door to an operating system Or web-based environment. Within the environment the user is required to present their identity, usually in the form of an assigned user name or email address.

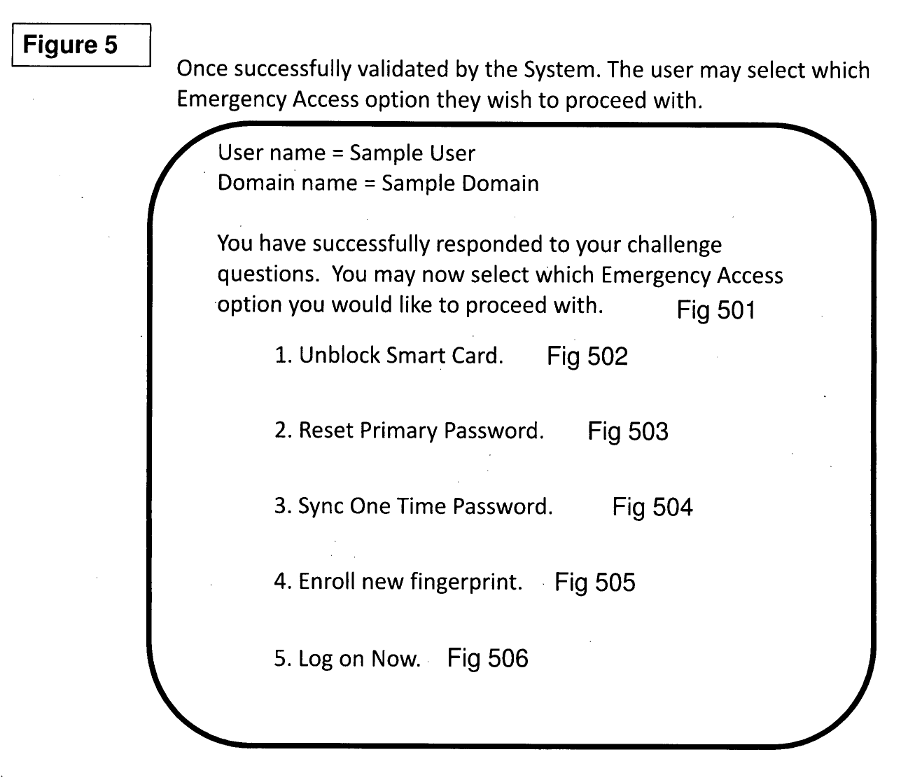

FIG. 5 then requires the user to provide some form of authentication such As a password, smart card, One-Time Password, fingerprint biometric or other means.

Once the user has provided this information, the system then attempts to validate the information against what is known by the system or some other source of validation. Once the user is validated the system authenticates the user and the user is granted access.

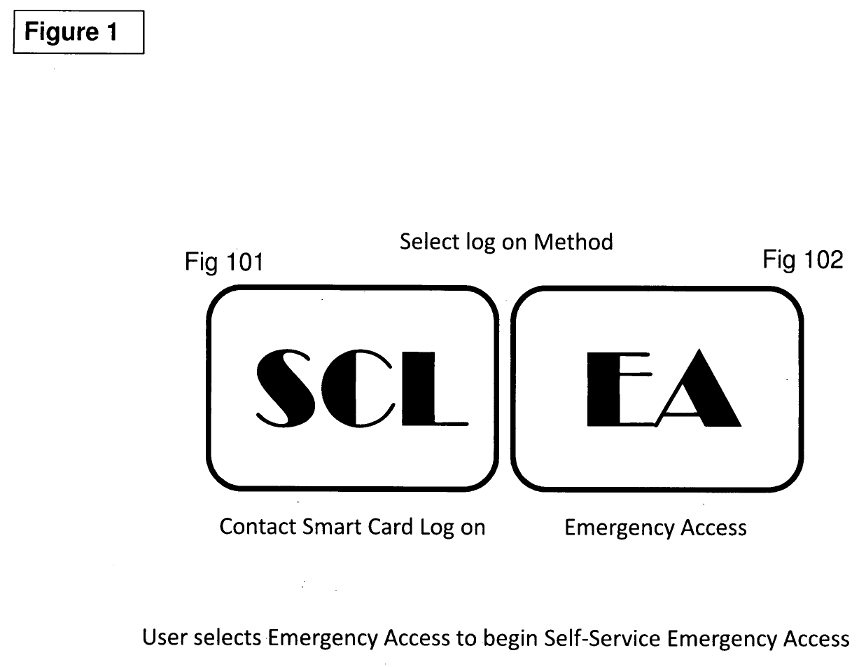

Within this invention, the user will first select a graphic or printed text within the log on environment, which informs the user that emergency access is available on the system as in FIG. 1.

Once emergency access is selected the user will provide their account name, the system will validate that an account exists for the user within the system.

The system will then present the user with a challenge. The challenge is independent of the invention, but should be of an equivalent strength to validate the user's identity (FIGS. 201, 202 and 203).

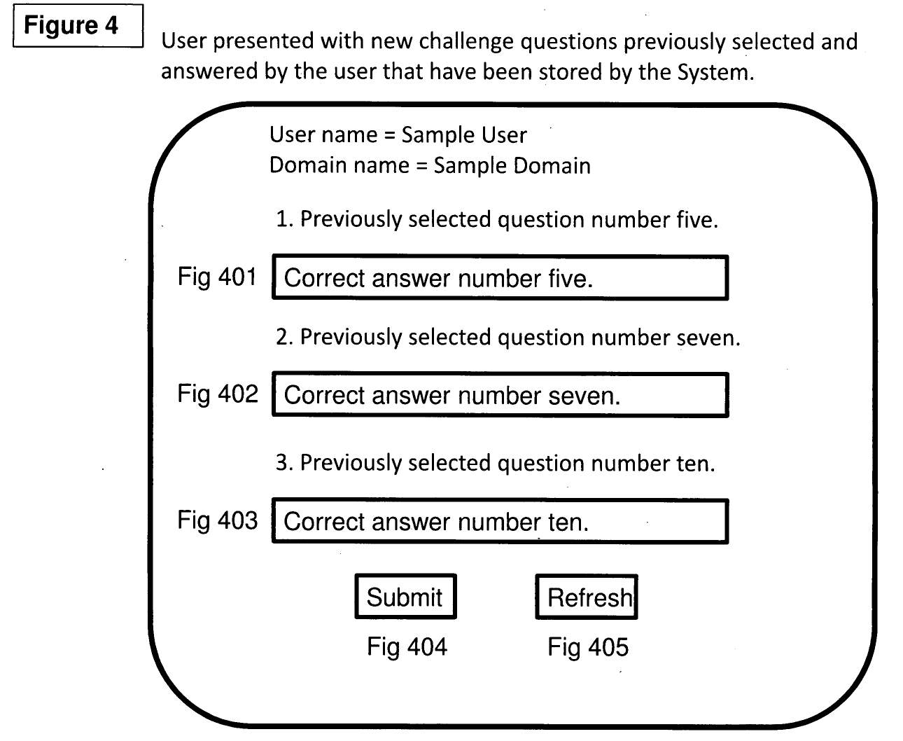

In FIG. 4 the user has successfully responded to the system challenge. In FIG. 5 the system presents the user with the available emergency access options within the system. These options could include, but are not limited to: unblock smart card (FIG. 502), reset password (FIG. 503), synchronize One-Time Password (FIG. 504), enroll new fingerprint (FIG. 505), or access the system now (FIG. 506).

1. A method for user authentication, the method comprising a multi-option logon environment.

2. A method of claim 1, wherein a person (hereinafter “user”) is presented with multiple routes with which to gain emergency access.

3. A method of claim 1, wherein self-service multi-option logon diminishes the requirement of administration assistance in order to acquire emergency access.

4. The method of claim 2, wherein the multiple routes may include password resetting.

5. The method of claim 2, wherein the multiple routes may include PIN resetting.

6. The method of claim 2, wherein the multiple routes may include unblocking the users smart card.

7. The method of claim 2, wherein the multiple routes may include enrolling a new fingerprint biometric.

8. The method of claim 2, wherein the multiple routes may include the user logging in.

9. A system for authenticating the authorization of a user comprising:
(a) an option based logon system;
(b) a multitude of options as chosen by the administrator;
(c) providing self-service access to users;
(d) the user choosing the logon method of their choice from the options available;
(e) the user satisfying the requirements of the logon method of their choice.
